(19) United States
(12) Patent Application Publication
(10) Pub. No.: US 2006/0025154 A1
(43) Pub. Date: Feb. 2, 2006

(54) System and method for locating persons or assets using centralized computing of node location and displaying the node locations

(75) Inventors: Pertti O. Alapuranen, Deltona, FL (US); Peter J. Stanforth, Winter Springs, FL (US)

Correspondence Address: GARDNER CARTON & DOUGLAS LLP;(MESHNETWORKS/MOTOROLA) ATTN: PATENT DOCKET DEPT., 191 NORTH WACKER DRIVE, SUITE 3700, CHICAGO, IL, 60606-1698, US

(73) Assignee: MeshNetworks, Inc., Maitland, FL (US)

(21) Appl. No.: 11/191,710

(22) Filed: Jul. 28, 2005

Related U.S. Application Data
(60) Provisional application No. 60/591,616, filed on Jul. 28, 2004.

(51) Int. Cl. H04Q 7/20

(52) U.S. Cl. 455/456.1; 455/457

(57) ABSTRACT

A system and method for providing position information of mobile user terminals (103) in a portable voice and data wireless communications network, such as an ad-hoc wireless communications network (100). More particularly, the present invention relates to a system of locating persons or assets using a centralized computing device, such as a server (125), that computes the respective locations of the terminals (103) from the respective information provided by the terminals (103) relating to their respective locations. A graphical display (121) that retrieves the location information from the centralized server (125) and generates a graphical display (121) of the location of all or selected terminals (103) based on their locations as computed by the server (125).

This application claims the benefit of U.S. Provisional Application No. 60/591,616, filed Jul. 28, 2004, the entire content being incorporated herein by reference.

### CROSS-REFERENCE TO RELATED APPLICATION

Related subject matter is disclosed in U.S. patent application Ser. No. 10/402,961 entitled “A System And Method For Determining Relative Positioning In Ad-Hoc Networks”, filed on Apr. 1, 2003, the entire content of which is incorporated herein by reference.

### FIELD OF THE INVENTION

The present invention relates to a system and method for providing position information of mobile user terminals in a portable voice and data wireless communications network, such as an ad-hoc multi-hopping wireless communications network. More particularly, the present invention relates to a system and method for locating persons or assets using a centralized device which computes the respective locations of the assets based on respective information provided by the assets, and employs a graphical display unit that generates a display of the locations of all or selected assets based on the computed locations.

### BACKGROUND

In recent years, a type of mobile communications network known as an “ad-hoc” network has been developed for use by the military, for example. In this type of network, each mobile node is capable of operating as a base station or router for the other mobile nodes, thus eliminating the need for a fixed infrastructure of base stations. As can be appreciated by one skilled in the art, network nodes transmit and receive data packet communications in a multiplexed format, such as time-division multiple access (TDMA) format, code-division multiple access (CDMA) format, or frequency-division multiple access (FDMA) format.

More sophisticated ad-hoc networks are also being developed which, in addition to enabling mobile nodes to communicate with each other as in a conventional ad-hoc network, further enable the mobile nodes to access a fixed network and thus communicate with other mobile nodes, such as those on the public switched telephone network (PSTN), and on other networks such as the Internet. Details of these advanced types of ad-hoc networks are described in U.S. patent application Ser. No. 09/897,790 entitled “Ad Hoc Peer-to-Peer Mobile Radio Access System Interfaced to the PSTN and Cellular Networks”, filed on Jun. 29, 2001, in U.S. patent application Ser. No. 09/815,157 entitled “Time Division Protocol for an Ad-Hoc, Peer-to-Peer Radio Network Having Coordinating Channel Access to Shared Parallel Data Channels with Separate Reservation Channel”, filed on Mar. 22, 2001, and in U.S. patent application Ser. No. 09/815,164 entitled “Prioritized-Routing for an Ad-Hoc, Peer-to-Peer, Mobile Radio Access System”, filed on Mar. 22, 2001, the entire content of each application being incorporated herein by reference.

In either conventional wireless communications networks, or in ad-hoc wireless communications networks, it may be necessary or desirable for a mobile node to be capable of knowing or determining its geographic location. Details of location determining services and techniques for wireless communications networks are described in a Nokia White Paper entitled “Mobile Location Services”, the entire content of which being incorporated herein by reference.

In particular, the Nokia document states that location identification services are currently provided in wireless communications networks based on three major technologies. One of these technologies uses cell identification combined with Round Trip Time (RTT), Timing Advance (TA) and Measured Signal level (RX level), Time Difference of Arrival (TDOA) and Angle Of Arrival (AOA) techniques, the details of which can be appreciated by one skilled in the art. A second technology uses cellular signal timing based methods for code division multiple access (CDMA) and wideband code division multiple access (WCDMA). The third technology described in the Nokia document employs Global Positioning System (GPS) techniques.

Another list of methods and techniques currently used in the wireless communications industry for providing location services is presented in an article by DISPATCH Monthly entitled “E911 Location Technologies”, the entire content of which is incorporated herein by reference. Although the GPS technique is the last technique mentioned in this list, it generally is viewed as being more accurate than all other methods listed. Further details and descriptions of GPS based methods are set forth in a publication by J. J. Spilker Jr. entitled “Satellite Constellation and Geometric Dilution of Precision” in “GPS—Theory and Applications”, American Institute of Astronautics, Inc., 1996, also in a publication by P. Axelrad et al. entitled “GPS Navigation Algorithms” in “GPS—Theory and Applications”, American Institute of Astronautics, Inc., 1996, also in a publication by Bradford W. Parkinson entitled “GPS Error Analysis” in “GPS—Theory and Applications”, American Institute of Astronautics, 1996, and in a publication by N. Ashby et al. Entitled “Introduction to Relativistic Effects on the Global Positioning System” in “GPS—Theory and Applications”, American Institute of Astronautics, 1996, the entire contents of each of these publications being incorporated herein by reference.

Despite the fact that the GPS technique has been in use for a considerable period of time and most of the world's navigation relies on this technique, the GPS technique is very susceptible to errors in measurement. Therefore, the GPS technique is capable of providing location determination results with very high accuracy only after performing a relative large number of measurements to remove such errors. A description of the shortcomings of GPS is set forth in a document by the Institute For Mathematics and its Applications (IMA) entitled “Mathematical Challenges in Global Positioning Systems (GPS)”, the entire content of which being incorporated herein by reference. Certain other tests also demonstrate that the GPS technique is unsuitable for terrestrial-based networks.

In addition, other methods and techniques which do not use GPS satellites for determining mobile station locations in a wireless communications network typically require that the signal from the mobile station be received by at least two cell sites that can measure and process the delay between signal arrivals, identify the direction of the signal based on “path signature” and determine the distance between the mobile station and the cell towers.

In all of these methods, the processing of the information is executed in a designated central processing unit (CPU) which is typically located at a cell tower next to the base station (BTS). Also, most of these methods were designed to comply with E911 requirements without requiring that excessive modifications be made to existing wireless communications systems. Examples of other location determining techniques are set forth in a document by Wendy J Woodbury Straight entitled “Exploring a New Reference System”, and in a document entitled “An Introduction to SnapTrac Server-Aided GPS Technology”, the entire contents of each of these documents being incorporated herein by reference.

To overcome the above issues with determining location information, ad-hoc networks are being developed which do not require either the use of satellites or a centralized computing facility for determining location information. Further details of such ad-hoc networks are described in U.S. Pat. No. 6,728,545 entitled “A System and Method for Computing the Location of a Mobile Terminal in a Wireless Communications Network”, the entire content of which is incorporated herein by reference.

Additionally, ad-hoc networks can be developed which utilize non-fixed, or movable infrastructure components which can provide a user with an absolute geographic location. Further details of networks using movable access points and repeaters for minimizing coverage and capacity constraints are described in U.S. patent application Ser. No. 09/929,030 entitled “Movable Access Points and Repeaters for Minimizing Coverage and Capacity Constraints in a Wireless Communications Network and a Method for Using the Same”, filed Aug. 15, 2001, the entire content being incorporated herein by reference.

As discussed above, in GPS and many other location systems, the actual terminal that receives or measures radio signals (TOF, TDOA or similar) computes location of the terminal by measuring time of flight or time difference of arrival signals or some other measurement. By having 4 measurements, x,y,z coordinates can be computed.

However, it can be desirable for a system to compute the locations of wireless terminals at a centralized location, such as at a centralized server.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an example ad-hoc packet switched wireless communications network including a plurality of nodes in accordance with an embodiment of the present invention;

FIG. 2 is a block diagram of an example of a mobile node employed in the network shown in FIG. 1;

FIG. 3 is a diagram of an example of a wireless router employed in the network shown in FIG. 1;

FIG. 4 is a diagram of an example of a wireless router as shown in FIG. 3 mounted on a portable structure in accordance with an embodiment of the present invention;

FIG. 5 is a diagram illustrating an example of how an embodiment the invention may be deployed in a fire/rescue scenario in accordance with an embodiment of the present invention; and

FIG. 6 is a diagram of an example of a mobile node which displays the location of deployed equipment and personnel in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention

### DETAILED DESCRIPTION

Before describing in detail embodiments that are in accordance with the present invention, it should be observed that the embodiments reside primarily in combinations of method steps and apparatus components related to a system and method for locating persons or assets using a centralized device which computes the respective locations of the assets based on respective information provided by the assets. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a system and method for locating persons or assets using a centralized device which computes the respective locations of the assets based on respective information provided by the assets, described herein. The non-processor circuits may include, but are not limited to, a radio receiver, a radio transmitter, signal drivers, clock circuits, power source circuits, and user input devices. As such, these functions may be interpreted as steps of a method to perform operating for locating persons or assets using a centralized device which computes the respective locations of the assets based on respective information provided by the assets. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Accordingly, as will now be discussed in detail, the present invention provides a system and method for using a centralized component, such as a centralized server, for computing the location of an ad-hoc multi-hopping terminal or other terminals that use radio links to communicate measurements to centralized server. The system and method can generate a display of wireless terminals, such as wireless ad-hoc terminals, upon computing the locations of those terminals at a centralized server based on measurements taken by those terminals and communicated to the server.

The wireless communication network includes a plurality of nodes that are adapted to transmit and receive signals to and from other nodes in the network. The network can be a wireless ad-hoc peer-to-peer multi-hopping network, or any other wireless network. The system and method distribute a plurality of nodes at a deployment area and enable the nodes to acquire location information about themselves. The nodes are controlled to provide the acquired location information to a calculating device. The calculating device is then controlled to calculate the respective locations of the nodes based on the respective location information. In addition, a display can be generated illustrating the respective locations of the nodes calculated by the calculating device.

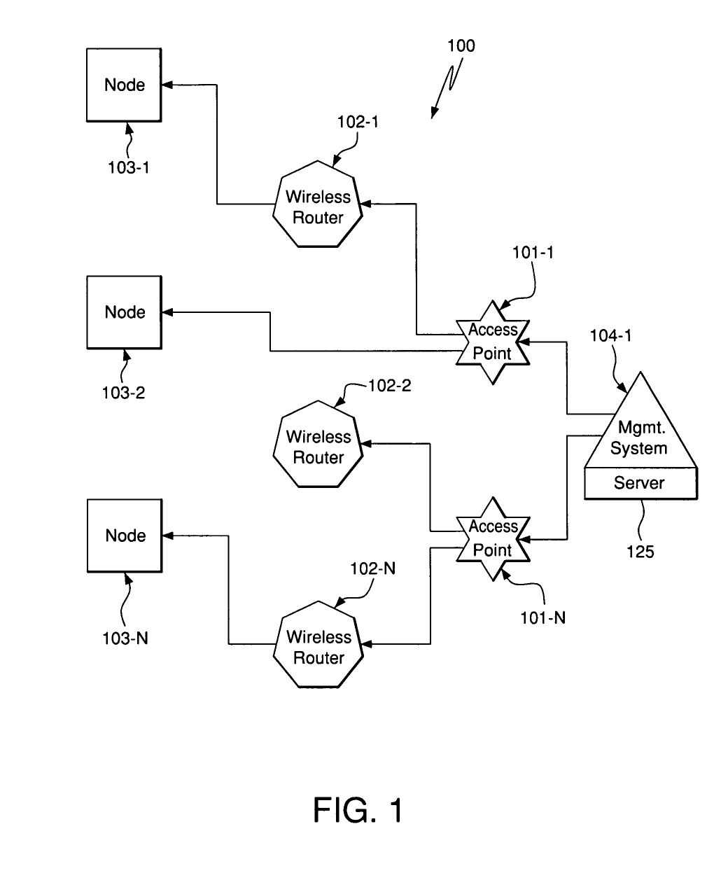

FIG. 1 is a block diagram illustrating an example of a wireless communications network 100 employing mobile access terminals in an example communication arrangement according to an embodiment of the present invention. As shown in FIG. 1, network 100, which can be referred to as a “portable network”, includes a plurality of terminals, including access points 101-1 to 101-n, wireless routers 102-1 to 102-n, mobile nodes 103-1 to 103-n, which can be collectively referred to as access points 101, wireless routers 102 and mobile nodes 103, and a network management system 104-1. It is noted that for purposes of this discussion, the terminals, can also be collectively referred to as terminals 101, 102 or 103, or nodes 101, 102 or 103, and the term “reference terminal” applies to both wireless routers and access points. The network management system 104-1 is an optional member of the network, providing enhanced network management and control functions. These functions include, but are not limited to, mobile node registration, authorization, and configuration, data logging, and system alarms.

The system and method of the preferred embodiment described below employs mobile access points, wireless routers, and mobile nodes which each contain at least one transceiver adapted to transmit and receive communication signals to and from other wireless routers, mobile nodes and other mobile access points. Each access point can be mounted to a mobile vehicle and receives substantially constant power from the vehicle. The access point may optionally be connected to a network management system which allows enhanced network monitoring and control. The wireless routers can be mounted to portable stands for easy deployment and are typically connected to a portable power source. The mobile nodes are battery powered, and are attached to equipment or personnel for tracking purposes. Each network node further includes technology which may enable a node to gather information pertaining to its absolute node location containing latitude, longitude and altitude information about itself, or a relative node location containing the distance and angle between itself an other nodes, or a combination of both absolute and relative location data.

The network management system 104-1 is an optional member of a fixed network that can include, for example, a core local access network (LAN), and a plurality of servers and gateway routers to provide network nodes with access to other networks, such as other ad-hoc networks, the public switched telephone network (PSTN) and the Internet. As can be appreciated by one skilled in the art, the nodes 101, 102 and 103 are capable of communicating with each other directly, or via one or more other nodes 101, 102 or 103 operating as a router or routers for packets being sent between nodes, as described in U.S. patent application Ser. Nos. 09/897,790, 09/815,157 and 09/815,164, referenced above. An example of such communication links are shown in FIG. 1, however, any number of communication arrangements can exist in the network 100 of FIG. 1.

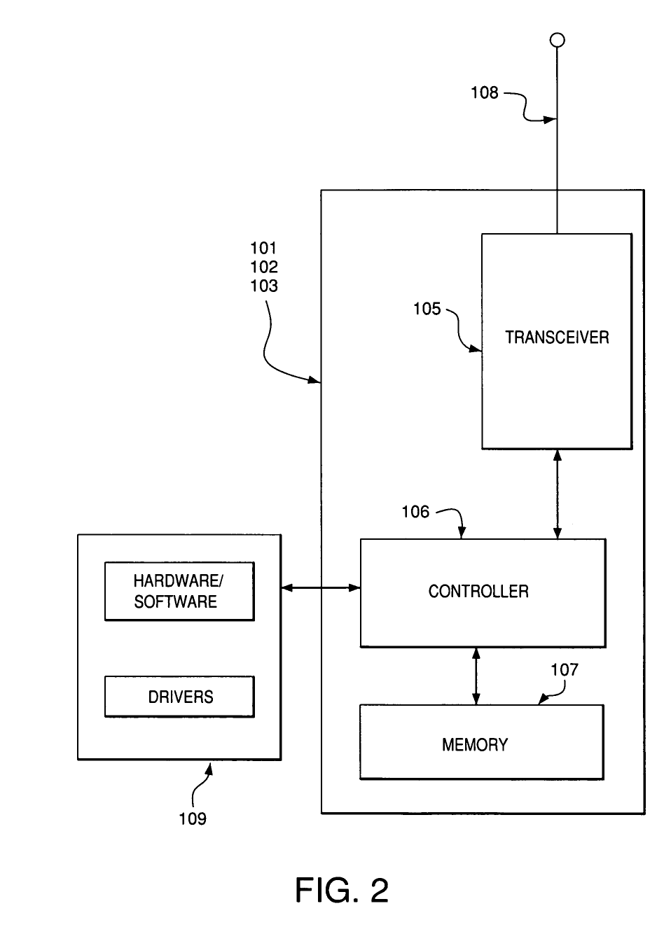

As shown in FIG. 2, each access point 101, wireless router 102, and mobile node 103 includes at least one transceiver 105 coupled with an antenna 108. The transceiver 105 is adapted to transmit and receive data packets over any frequency band, such as the Industrial, Scientific and Medical (ISM) band. However, the frequency and modulation scheme used by the transceiver 105 does not impact the implementation of the access points, routers, or nodes.

Each access point 101, wireless router 102, and mobile node 103 further includes at least one processor, or controller 106, and a memory module 107 used for processing and storing information such as location and routing information. As further shown in FIG. 2, certain mobile nodes 103 may include a host 109 such as a notebook computer, a personal digital assistant (PDA), a mobile data unit or any other suitable device.

The mobile access point 101 of FIG. 1 can be physically constructed to be quite small, so as to be mounted on the interior or exterior of a vehicle, such as an automobile, truck, bus, train, taxi, police car, fire engine, or any other suitable movable vehicle. The antenna 108 of the mobile access point 101 can be internally or externally mounted to the vehicle and can have a gain higher than that of an antenna 108 similarly employed at a mobile node 103. The importance of this variation in antennae gain is described in greater detail below.

In applications in which the access point 101 is fixed on a vehicle, the access point can also include a connection to a substantially constant external power supply, such as the 12V DC power supply provided by the attached vehicle. In doing so, each mobile access point 101 can communicate with mobile nodes, other access points, and with the network management system 104-1 which provides the enhanced network management and control functions implemented throughout the network 100.

A mobile access point 101, wireless router 102 and mobile node 103 can further include positioning functionality, such as global positioning systems (GPS), differential navigation systems, or other positioning systems, such as those described in U.S. Pat. No. 6,728,545, referenced above, as well as other various techniques as can be appreciated by one skilled in the art. These, and other similar systems, enable each access point and wireless router to determine its relative and actual geographic location, which can be provided to other elements of the network 100 during operations, such as when any mobile node is attempting to use the mobile access point as an access point in the network 100. Additional details of such positioning systems are further discussed in U.S. patent application Ser. No. 09/973,799 filed on Oct. 11, 2001, entitled “System and Method for Efficiently Performing Two-Way Ranging to Determine the Location of a Wireless Node in a Communication Network”, in U.S. patent application Ser. No. 09/996,603 filed on Nov. 30, 2001, and in U.S. Pat. No. 6,728,545, referenced above, the entire contents of each being incorporated herein by reference.

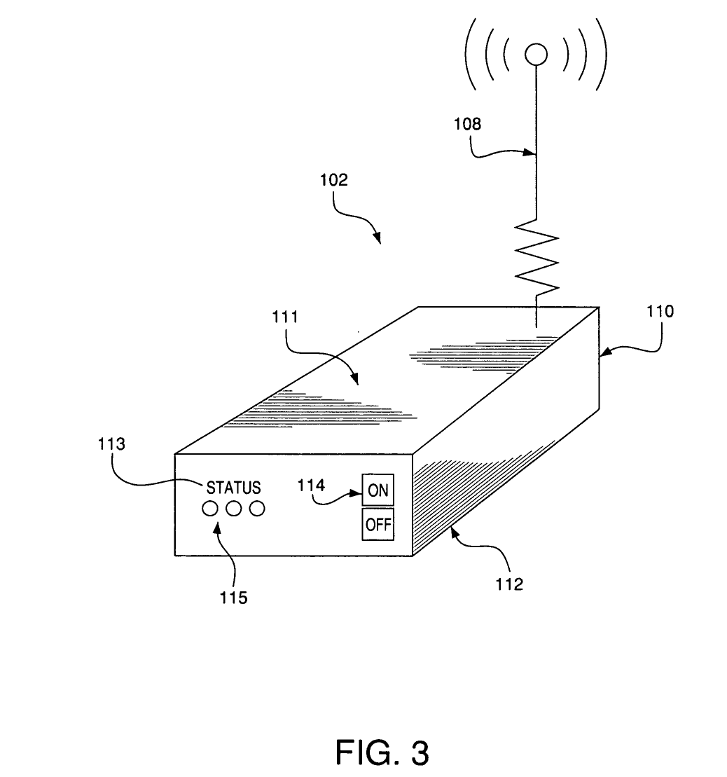

In FIG. 3, a diagram of an example wireless router 102 used in the network 100 of FIG. 1 is shown. The router includes a housing 110, which can be constructed as a rectangular box with a top side 111 mechanically coupled with a bottom side 112, each having dimensions, for example, of approximately 3 inches by 4 inches. The top and bottom sides are separated by four perimeter sides creating an overall dimension for the wireless router of 3 inches by 4 inches by 1 inch. These dimensions are presented as examples for use in this embodiment, however alternate embodiments can use dimensions adapted for any particular installation or use.

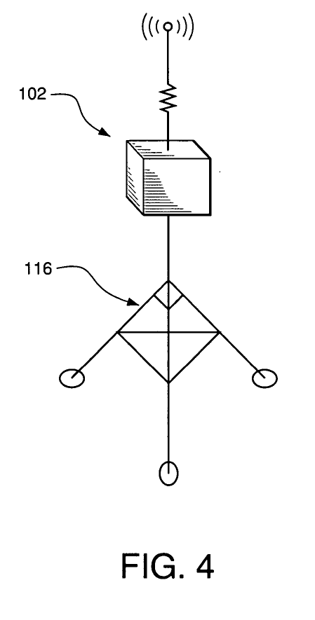

A first perimeter side 113 can be used to mount operator interface controls and indicators within a series of openings. Such controls and indicators can include a simple to use on-off switch 114 and router status indicators 115. As known to those skilled in the art, the portable wireless router 102 can include a connection to a power supply (not shown) which may be either internal or external to the device, and a mounting mechanism (not shown) which allows the router to be mounted on a portable structure as shown in FIG. 4. FIG. 4 is a conceptual diagram of a wireless router as shown in FIG. 3 mounted on a portable structure 116, allowing the antennae of the router 102 to operate at a level approximately five to six feet from the deployment surface.

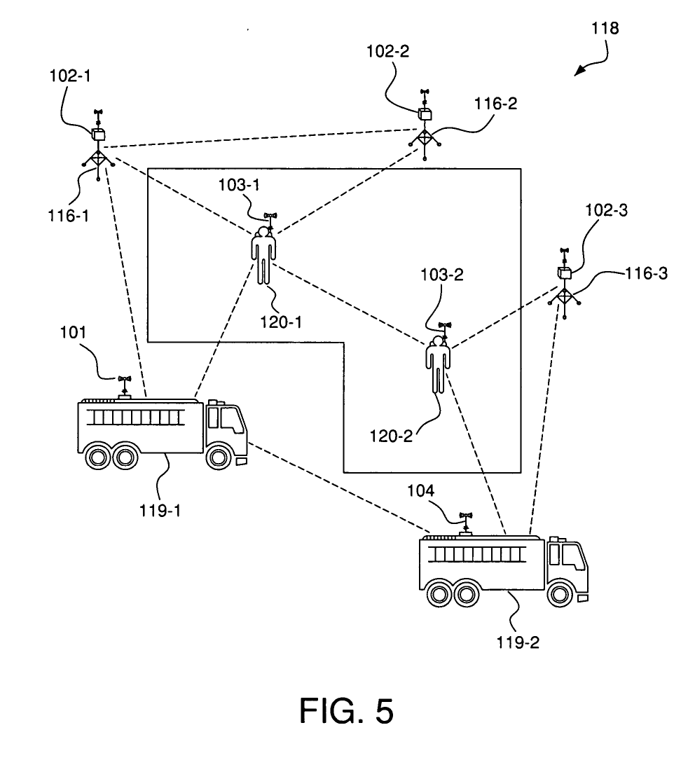

FIG. 5 is a conceptual diagram of how an embodiment of the present invention can be deployed, such as in a fire rescue scenario 118, in accordance with an embodiment of the present invention. In a typical fire rescue scenario, several rescue vehicles, such as fire vehicles 119-n may be present at a location, about which, many individual fire personnel 120-n may be working. Upon arrival, or at locations perhaps known to frequently require fire rescue presence, multiple routers 102-n and portable structures 116-n may be placed about a work area. FIG. 5 shows an example deployment where an access point 101 and the network management system 104-1 are located in rescue vehicles 119-1 and 119-2, respectively, wireless routers 102-1, 102-2 and 102-3 are deployed about the area on portable structures 116-1, 116-2 and 112-3, respectively, and individual personnel 120-1 and 120-2 are each carrying mobile nodes 103-1 and 103-2, respectively. As shown in FIG. 5, each mobile node 103 can communicate with other mobile nodes either directly, or indirectly using the wireless routers 102, access point 101, or network management system 104-1. Each mobile node may also communicate with the network management system 104-1 either directly, or indirectly in a similar fashion. Since numerous routers 102 are distributed about the area, communication links between mobile nodes may be handed off from one device to another as the mobile node moves about the area.

As noted above, nodes can be provided antennae and corresponding communication controls of variable gain. For example in FIG. 1, the mobile access point 101 can have a gain higher than that of mobile node 103. Still further, each node can include an “emergency power boost button”, which increases gain, or power output of the transceiver, for increased range or in-building wall/floor signal penetration. Normally the routers 102 and mobile nodes 103 operate within Federal Communications Commission (FCC) limits, however in emergency mode each can output at levels above normal FCC limits, or above normal battery operation levels that are set to maximize battery life.

As can be appreciated from the above, the embodiments of the present invention described herein may be applied in a number of scenarios, however for illustration purposes, the description below presents the embodiment applied to an emergency services deployment scenario. The primary aim is to allow emergency personnel, individually or in teams, to locate other emergency personnel and assets in an emergency deployment environment. In the embodiment shown, emergency teams take all the required systems and equipment with them, which may then be quickly deployed and operated, then later removed. As noted earlier, in an alternate embodiment in which deployment regularly occurs or assets are managed and stored, such equipment may be deployed and left in place.

In the deployment described below, the embodiment does not require absolute positioning for tracking personnel and assets, as relative positions are sufficient. In other words, a fireman needs to know where he is relative to the entrance of a building and other firemen and equipment, but does not need to know that a location is in New York or Los Angeles.

As shown in FIG. 5, access points 101 are located in fire trucks or other vehicles 119 located at various positions about the deployment area 118. Multiple wireless routers 102, mounted on raised devices 116, are deployed away from the access points 101 to allow accurate location and radio frequency (RF) coverage for the area. Mobile nodes 103 are used by each emergency personnel 120 and other assets (not shown) to allow tracking and locating throughout the deployment area 118. As mobile nodes 103 are deployed, communications are established between mobile nodes 103, wireless routers 102, access point 101 and the network management system 104-1. As described in more detail below, the network management system 104-1 will be able to manage overall deployment, such as locating and tracking all personnel, equipment and vehicles at the scene.

In an example implementation of an embodiment of the present invention, the deployment area 118 is first identified and emergency vehicles 119-1 and 119-2 arrive. Emergency personnel 120-1 and 120-2 deploy multiple wireless routers 102-1, 102-2 and 102-3 to provide area coverage as shown in FIG. 5. Each individual fire personnel 120 and asset (not shown) carries a mobile node 103 and is free to enter any building at the scene with full voice and data communication established and maintained between each other, either directly, or via the deployed wireless routers 102 using the mobile node 103 and associated attached host device 109. Each mobile node 103 also allows communication capability with the network management system 104-1 located at a vehicle 119-2 at the deployment area. As discussed in more detail below, the network management system 104-1 will each display relative locations of each device 101, 102, 103 and 104-1 by showing the location of the personnel, vehicles and wireless routers in the portable network. Absolute location can also be displayed if the access points 101 and wireless routers 102 have a location capability such as GPS. This relative and/or actual location information can also be sent to the nodes 101, 102 and 103 for display.

As can be appreciated by one skilled in the art, buildings provide additional challenges to wireless communication, and coverage within buildings at the deployment area 118 shown in FIG. 5 may be limited or non-existent in some circumstances. In cases where buildings pose coverage difficulties, the embodiment of the present invention shown in FIG. 5 can provide a very simple and cost effective solution. Since the wireless router 102 is a small device as shown in FIG. 3, it can easily be carried into any location, floor or stairwell, within a building by firemen. As firemen reach the limit of communication coverage between the exterior and interior of a building, they can deploy a wireless router 102 to serve as a three-dimensional bridging communication link, or “bread crumb”, and extend coverage further into the building interior. This extended fireman's connection to the building exterior can now be “daisy chained” through one or more wireless routers 102 deployed at the scene and throughout the building. Furthermore, depending upon the deployment of the wireless routers, three-dimensional location determination can also be accomplished and provided to the network management system 104-1.

In a firefighting scenario or fire and rescue scenario such as that described above, a lost firefighter can be located by measuring distances to other nodes 102 and 103, for example. In accordance with an embodiment of the present invention, mobile nodes 103 do not compute their own location, but instead, they use the network 100 to communicate their measurement information to a centralized server 125 (see FIG. 1) that can be present, for example, at the management system 104-1 and collects measurements from all nodes 101, 102 and 103. However, the centralized server 125 can be located at any other practical location. These measurements are done between all nodes that are part of the location task.

For example, in a firefighting or fire and rescue scenario, all the nodes (e.g., nodes 101, 102 and 103) at the scene report their distances to all other nodes 101, 102 and 103 and send the measurements to the centralized server 125 using the radio links of the network 100 or other links. Centralized server 125 computes the actual x,y,z coordinates of all or selected nodes 101, 102 and 103 by using the reported measurements. Hence, because all the measurements are collected at one location, that is, at the centralized server 125, very efficient algorithms can be used to reduce measurements to location information in Cartesian, polar or other coordinate system. If a node, for example, a mobile node 103, needs to know its position, then it sends a request using communications links of the network 100 as described above to the centralized server 125 that reports back the computed coordinates. Again, in this embodiment, none of the nodes know their coordinates without requesting them from the server 125.

In this embodiment, communications to the server 125 that computes actual location from measurements can be unidirectional or bidirectional. For example, each node can report their distance or time-of-flight measurements acquired as discussed above, or any other radio signal measurements, to the centralized server 125 using radio links of the network 100. Also, the network 100 does not need to be an ad-hoc peer-to-peer multihopping network as described above, but rather, can be any type of communication network that employs radio links to communicate the measurements.

In addition, the measurements can be sent by the nodes using broadcast transmission. In this case, multiple servers 125 can exist where each server receives broadcast measurement signals and independently computes the locations of the nodes (e.g., nodes 103) that reported their measurements. Likewise, any individual node can request its coordinates from any of the multiple servers 125. The servers 125 advertise their existence by sending messages over radio or other links of the network 100 pertaining to their respective MAC, IP or other address. Nodes 101, 102 and 103 can use that information to then access the desired server or servers 125. A server 125 can also be accessed using an Ethernet, WAN, LAN, cellular data or other type of data link.

Further, in accordance with an embodiment of the present invention, if one node (e.g., a node 103) is capable of acquiring information pertaining to its absolute coordinates, for example GPS coordinates, then this node 103 can transmit its known coordinates to the centralized server or servers 125 which can use these coordinates to compute coordinates of other devices by using translation and rotation calculations. When enough known coordinates are transmitted to centralized server or servers 125, then the server or servers 125 can compute absolute coordinates for all nodes 101, 102 and 103 relating to coordinate system that is known, for example, a GPS coordinate system.

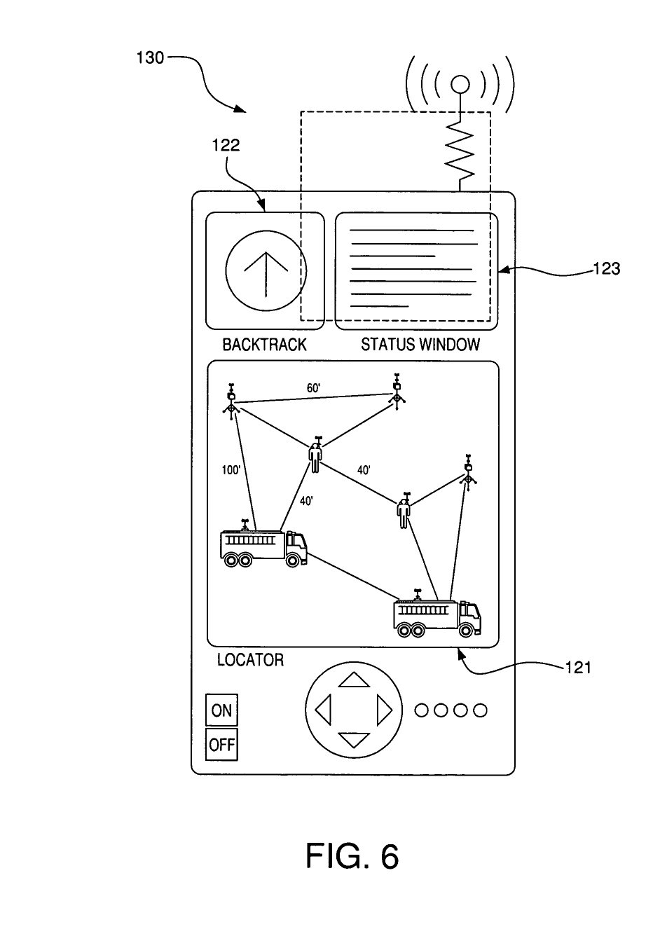

The centralized server or servers 125 can also report the coordinates of all nodes 101, 102 and 103 to a user interface 130 as shown in FIG. 6, that displays the coordinates graphically. As indicted, the interface 130, which can itself be a mobile or stationary node of the type discussed above, or any other type of suitable device such as a personal computer (PC), laptop or notebook, PDA and so on, contains a graphics window 121 for displaying the location of the devices in the portable network 100, a backtrack button 122 which allows the user to retrace his steps, and a status window 123 for textual information. Alternate operator interface controls may be included in other embodiments, or where merely attached to assets, minimal controls may be provided. In the embodiment shown in FIG. 6, only relative locations are displayed. For example, the deployment of nodes 101, 102 and 103 of FIG. 5 are shown via the graphics window 121 of mobile node 103, including distance and direction of each. In yet another embodiment wherein the access points 101 and wireless routers 102 contain absolute location information, the latitude, longitude and altitude of each could also be displayed. Also, access points 101, wireless routers 102, and network management system 104-1 can include these display features and functionality as well.

This user interface 130 can display different device types using different markers or colors. For example lost person or asset can be different color or marker than known devices. Also, nodes that are used for reference, such as nodes 101 or 102, can be displayed using different colors. Also, the user interface 130 can be used to name the nodes by allowing a user to type the name of the person or asset that will be displayed on the screen. A user can also attach parameters to a list of nodes that is displayed in graphical or text form, for example, nodes' relative positions to other nodes can be entered, and the meaning of the location can be entered. For example, one node (e.g., a node 102) can be selected to be the origin, another node 102 as an x-axis point with respect to the origin, and a third node 102 as a y-axis point with respect to the origin, or similarly, the relations of node locations can be entered and displayed.

The user interface 130 can further be used to find closes person or asset relative to other, for example, the closest person or asset relative to some other can be displayed differently in user interface graphical screen. Additional information related to location computation can be sent to centralized server 125. For example, a sensor can be present on a mobile node 103 and used to determine if the node 103 moves. If the node 103 moves, then this information can be communicated to the server 125 and measurements can be handled differently than those from nodes that are stationary, such as nodes 101 and 102. The rate of movement of a node 103 can be used to filter location information, for example, averaging, Kalman filtering as known in the art (See, e.g., Greg Welch and Gary Bishop, “An Introduction to the Kalman Filter”, TR 95-041, Univ. of North Carolina, April, 2004, incorporated herein by reference), or using any other suitable filtering process can be used to enhance accuracy if information is available that node 103 does not change too rapidly, that is, if the node 103 does not move too fast. In addition, acceleration sensors can be present at each node 103 or select nodes 103 to determine if those nodes 103 move and to estimate their respective rate of movement. It is noted that apriori acceleration information that is known to represent typical acceleration or movement for the type of asset being monitored, or measured acceleration information about movement of the asset, can be used for adjusting tracking parameters of the Kalman filtering or any other suitable type of filtering that can be performed by the server 125.

The graphical user interface 130 can further be used to show additional information related to nodes and their respective surroundings. For example, temperature measurements or other measurements related to a location can be transmitted to the centralized server or servers 125. Centralized server or servers 125 determines the location of measurement based on measured time of flight, TDOA, received signal strength indicator (RSSI) or similar measurements in the manner discussed above, and can attach the additional location information, such as temperature, etc., to a location for display.

Another example of the use of relative positioning in accordance with an embodiment of the present invention is “backtracking” or path documentation using the mobile node 103 and the deployed wireless routers, or “breadcrumbs” described above. When enabled, this feature will keep up to a three-dimensional track of the movements of the fire fighter from a first origination point, such as a vehicle or home position, to a present point. In doing so, the fire fighter can use the path documentation, or “breadcrumb” trail, to retrace his steps back to the fire truck when the application replays this information in reverse upon the display features of the interface 130, which can also be provided to the mobile node 103 for display, assuming that that mobile node 103 has display capabilities. Still another feature of the embodiment of the present invention disclosed above is the ability to locate disabled personnel. In a manner similar to the path documentation feature described above, the central server or servers 125 can be used to determine and communicate the position of a disabled mobile node user at the deployment scene, and the direction, distance and path from other mobile nodes, thereby allowing the disabled user to be located electronically.

Additional applications of the embodiment relate to other emergency services. The small size of the mobile nodes 103 and relatively low cost, allow their use in tracking any deployment of personnel or assets. This might include assets such as generators or defibrillators, or personnel such as patients in a triage unit. Still other applications can include deployments wherein police dogs are tracking suspects and various police units are arriving, and each may be easily detected, positioned and referenced.

A significant benefit of the present embodiment is that assets can be tracked and located quickly without the need for GPS systems. As can be appreciated by those skilled in the art, GPS systems suffer from being slow to initially synchronize, and typically require line of sight communication. Such devices are often ineffective in congested, or “built up” areas. The embodiment described above does not require the cost and complexity of GPS or the absolute location that such systems provide.

In summary, in accordance with an embodiment of the present invention described above, all nodes 101, 102 and 103, or at least selected nodes 101, 102 and 103, report their measurements to centralized server or servers 125. Measurements can be communicated from the nodes 101, 102 and 103 to centralized server or servers 125 by a single respective radio link or multiple links. The reporting is done over radio link or links of the network 100, which can be unidirectional from a node to the server or servers 125 or bidirectional. The radio network can be a wireless ad-hoc peer-to-peer multihopping network as described above, but alternatively can be any suitable wireless network. The centralized server or servers 125, which can be referred to generally as a calculating device, compute location information from the measurements, and a graphical user interface 130 request location information of selected devices from server 125 and displays that information. The graphical user interface 130 can be used to enter information about relational positions of nodes and that information is sent to centralized computing server or servers 125. The graphical user interface 130 can further be used to select nodes that are displayed, and can be used to select nodes that are used for location computations.

Furthermore, the graphical user interface 130 can be used to inform a location computation server 125 about parameters of nodes, for example, if a node is moving or not moving, the type of node, a display mode and so on. The node movement parameters are communicated to centralized server 125, and the rates of node movements can be measured using acceleration sensors as discussed above. Furthermore, each node or selected nodes can contain a compass that informs the centralized server or servers 125 of the direction in which it is heading, and this information can be used to determine the direction of movement or the method for filtering the data from a node. Furthermore, the node movement rate can be used to determine filtering or processing method for node measurements or computed location information, and the graphical user interface 130 can be used to attach additional information, for example, temperature, compass heading, and so on, to the location information.

In addition, if a node 101, 102 or 103 needs to know its location, it requests its calculated location information from a centralized location server 125. Also, although a respective location server 125 can run in each node, but each server 125 has to use the same set of measurements acquired from the nodes so that computed locations are the same.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Although only a few exemplary embodiments of the present invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined.

What is claimed is:

1. A method for determining node location information in a wireless communications network, the network including a plurality of nodes being adapted to transmit and receive signals to and from each other, the method comprising:
distributing a plurality of nodes at a deployment area and enabling the nodes to acquire location information about themselves;
operating each of the nodes to provide their respective acquired location information to a calculating device; and
operating the calculating device to calculate the respective locations of the nodes based on the respective location information.

2. A method as claimed in claim 1, further comprising:
generating a display illustrating the respective locations of the nodes calculated by the calculating device.

3. A method as claimed in claim 2, wherein the generating step comprises:
operating the calculating device to provide data representing the calculated respective locations to a user interface; and
operating the user interface to display the respective locations of the nodes based on the data.

4. A method as claimed in claim 1, further comprising:
distributing a plurality of stationary nodes; and
operating the nodes to acquire the location information about themselves based on interaction with the stationary nodes.

5. A method as claimed in claim 1, further comprising:
operating at least one of the nodes to request its respective location information from the calculating device.

6. A method as claimed in claim 1, wherein the calculating device operating step comprises:
filtering the respective location information of the respective nodes based on respective known behavior of the respective nodes.

7. A method as claimed in claim 1, wherein the calculating device operating step comprises:
filtering the respective location information of the respective nodes based on respective measurement information provided by each of the respective nodes about its own movement.

8. A wireless communications network, comprising:
a plurality of nodes, adapted to transmit and receive signals to and from each other, and further adapted for distribution at a deployment area and operable to acquire location information about themselves; and
a calculating device;
each of the nodes being further adapted to provide their respective acquired location information to the calculating device, and the calculating device being adapted to calculate the respective locations of the nodes based on the respective location information.

9. A wireless communications network as claimed in claim 8, further comprising:
a display device, adapted to generate a display illustrating the respective locations of the nodes calculated by the calculating device.

10. A wireless communications network as claimed in claim 9, wherein:
the calculating device is adapted to provide data representing the calculated respective locations to the display device; and
the display device is adapted to display the respective locations of the nodes based on the data.

11. A wireless communications network as claimed in claim 8, further comprising:
a plurality of stationary nodes; and
the nodes are adapted to acquire the location information about themselves based on interaction with the stationary nodes.

12. A wireless communications network as claimed in claim 8, wherein:
the nodes are further adapted to request their respective location information from the calculating device.

13. A wireless communications network as claimed in claim 8, wherein:
the calculating device is further adapted to filter the respective location information of the respective nodes based on respective known behavior of the respective nodes.

14. A wireless communications network as claimed in claim 8, wherein:
the calculating device is further adapted to filter the respective location information of the respective nodes based on respective measurement information provided by each of the respective nodes about its own movement.

15. A system, adapted for us with wireless communications network comprising a plurality of nodes, adapted to transmit and receive signals to and from each other, and further adapted for distribution at a deployment area and operable to acquire location information about themselves, the system comprising:
a transceiver, adapted to receive respective acquired location information from the respective nodes; and
a calculating device, adapted to calculate the respective locations of the nodes based on the respective location information.

16. A system as claimed in claim 15, further comprising:
a display device, adapted to generate a display illustrating the respective locations of the nodes calculated by the calculating device.

17. A system as claimed in claim 16, wherein:
the calculating device is adapted to provide data representing the calculated respective locations to the display device; and
the display device is adapted to display the respective locations of the nodes based on the data.

18. A system as claimed in claim 15, wherein:
the calculating device is further adapted to send, via the transceiver, the respective location information of a said node that requests the respective location information from the calculating device.

19. A system as claimed in claim 15, wherein:
the calculating device is further adapted to filter the respective location information of the respective nodes based on respective known behavior of the respective nodes.

20. A system as claimed in claim 15, wherein:
the calculating device is further adapted to filter the respective location information of the respective nodes based on respective measurement information provided by each of the respective nodes about its own movement.
